(19) United States
(12) Patent Application Publication
(10) Pub. No.: US 2020/0234373 A1
(43) Pub. Date: Jul. 23, 2020

(54) DIGITAL WEALTH MANAGEMENT ADVISOR

(71) Applicant: Steven F. Graver, Lake Bluff, IL (US)

(72) Inventor: Steven F. Graver, Lake Bluff, IL (US)

(21) Appl. No.: 16/750,263

(22) Filed: Jan. 23, 2020

Related U.S. Application Data
(60) Provisional application No. 62/795,619, filed on Jan. 23, 2019.

(51) Int. Cl. G06Q 40/06; G06Q 40/04; G06F 9/451; G10L 15/22; G06N 5/04; G06F 3/16

(52) U.S. Cl. CPC G06Q 40/06; G06Q 40/04; G06F 9/453; G10L 2015/221; G06N 5/04; G06F 3/167; G10L 2015/223; G10L 15/22

(57) ABSTRACT

A digital wealth management advisor is provided. The digital wealth management advisor includes an information-gathering unit, a financial-processing unit, and an information-production unit. The digital wealth management advisor is connected to a network that is connected to a customer-accessible computer. A customer can use the customer-accessible computer to ask the digital wealth management advisor a financial question in real time and the digital wealth management advisor will tailor an answer to the customer's financial question. The digital wealth management advisor will tailor the answer to the customer's question using artificial intelligence that takes into account the customer's current financial data, the customer's prior financial data, and the customer's projected financial data.

### CROSS-REFERENCE TO RELATED APPLICATIONS

This application claims the benefit of and priority from U.S. Provisional Patent Application Ser. No. 62/795,619, filed Jan. 23, 2019, which is hereby fully incorporated herein by reference.

### FIELD OF THE INVENTION

This invention generally relates to a Digital Wealth Management Advisor system and method for providing the same, and more particularly to a Digital Wealth Management Advisor system and related method that provides real time and customized financial advice.

### BACKGROUND OF THE INVENTION

Financially prudent individuals develop financial plans that help them achieve their financial goals. Traditionally, many of these individuals have entrusted their financial plans to personal financial advisors. However, personal financial advisors can be prohibitively expensive for many individuals who would otherwise wish to seek the expertise of a personal financial advisor. This lack of access to personal financial advisors has led to the chronic lack of savings both in the United States and abroad. Therefore, there is a need for a digital wealth management advisor system that can provide prudent financial advice to the masses, but at a significantly reduced cost compared to personal financial advisors.

Due to the significant costs associated with personal financial advisors, many individuals are turning to computer-based systems that organize their financial assets and liabilities and further provide them with a summary of their financial health. However, these systems tend to focus on the administrative aspects of financial planning without providing real time and customized financial advice to a customer, such that the customer can be informed before making a financial decision.

Further, many existing financial management systems allow users to electronically organize their financial assets and liabilities. These systems typically focus on presenting the user with a summary of their financial transactions over a given period of time and their financial health, at a given instance. As a result, these systems are merely data-driven calculators that are incapable of providing the user with meaningful tailored financial advice in real time, such that a customer can use their individually tailored financial advice when making a financial decision.

Similarly, some financial management systems present a static view of the user's financial health. These systems typically require the user to provide the most current financial data relating to their financial assets and liabilities. Consequently, when the user wishes to develop or update his or her financial plan, the user must input his or her most recent financial information. This problem is further exacerbated by the fact that these systems demand a lot of typing and guessing when the user enters financial data. This process is time-consuming and inefficient, which results in customers being overwhelmed by the interactions of the various financial variables that need to be considered when making a financial decision.

Currently, no web- or software-based wealth management advisor platform exists that dynamically incorporates all of the user's financial assets and liabilities to provide a customer with financial advice that can actually be used and processed by a customer during real life financial transactions. Further, no web- or software-based wealth management advisor uses artificial intelligence to learn the behaviors of an individual customer to understand how the customer financially behaves and to “push back” on the customer when the customer's proposed course of action is projected to negatively affect the customer's financial future.

Embodiments of the invention provide such a Digital Wealth Management Advisor system that provides the customer with live and customized financial advice by using artificial intelligence to project the financial position of the customer based on various courses of action the customer may take in one or a number of financial transactions. In addition to providing a solution that is lower-cost, embodiments of the present invention provide features and advise that cannot be provided by a human personal financial advisor. These and other advantages of the invention, as well as additional inventive features, will be apparent from the description of the invention provided herein.

### BRIEF SUMMARY OF THE INVENTION

In one aspect, embodiments of the present invention provide a digital wealth management advisor system comprising a digital wealth management advisor. The digital wealth management advisor including an information gathering unit, a financial processing unit, and an information production unit. The digital wealth management advisor system also includes a customer accessible computer. The digital wealth management advisor and the customer-accessible computer are connected to a network, such that the customer accessible computer and the digital wealth management advisor are communicable over the network. The information-gathering unit is capable of receiving a question from the customer-accessible computer, the financial-processing unit is capable of determining an answer to the customer's question, and the information-production unit is capable of sending the answer to the customer's question to the customer-accessible computer.

In another aspect, the digital wealth management advisor system where the customer-accessible computer is a cellular device with a microphone and a speaker.

In yet another aspect, the digital wealth management advisor system includes voice-recognition technology, such that a user can ask a question to the digital wealth management advisor using the microphone of the cellular device.

In still yet another aspect, the digital wealth management advisor system includes voice-recognition technology, such that a user can receive an answer to a question from the digital wealth management advisor via the speaker of the cellular device.

In another aspect, the digital wealth management advisor system's financial processing unit is programmed with artificial intelligence that takes into account the customer's live financial data and the customer's prior financial history to produce the answer to the customer's financial question.

In yet another aspect of the digital wealth management advisor system, the financial-processing unit is programmed with artificial intelligence that takes into account the customer's live financial data and the customer's prior financial history in relation to the financial history and results of all customers to produce the answer to the customer's financial question.

In still another aspect, the digital wealth management system is run on an application downloaded to the cellular device.

In another aspect, a digital wealth management advisor is provided. The digital wealth management advisor is comprised of an information-gathering unit that receives financial-questions input on a computer by a customer. The information-gathering unit is communicably coupled to a financial-processing unit over a network, such that the information-gathering unit submits the financial question received by the information-gathering unit to the financial-processing unit. The financial-processing unit retrieves the customer's financial data, processes the customer's question in view of the customer's financial data to provide an answer to the customer's questions. The financial-processing unit is communicably coupled to an information-production unit that is communicably coupled to a display device of the computer. The information-production unit instructs a display device on the computer to display the answer to the customer's question for review by the customer.

In another aspect, the digital wealth management advisor operates using a computer that is an electronic device.

In yet another aspect, the digital wealth management advisor is run by an application downloaded on the electronic device.

In still another aspect, the customer's financial data operated on by the digital wealth management advisor includes the customer's previous financial data, the customer's current financial data, and the customer's projected financial data.

In yet another aspect, the digital wealth management advisor's computer includes a speech recognition program and the customer audibly submits the financial question to the information-gathering unit.

In still another aspect, the digital wealth management advisor's computer includes a speaker and a virtual voice program, and the information-production unit audibly provides an answer to the customer's question.

In yet another aspect, the digital wealth management advisor's financial-processing unit is communicatively coupled to an artificial intelligence program and the artificial intelligence program provides the answer to the customer's question.

In still another aspect, the digital wealth management advisor's artificial intelligence program calculates the answer to the customer's question based on the customer's previous financial history.

In yet another aspect, the digital wealth management advisor's artificial intelligence program calculates the answer to the customer's question based on the customer's current financial position.

In still another aspect, the digital wealth management advisor's artificial intelligence program calculates a projected financial future for the customer based on the customer's previous financial history and the customer's current financial position.

In yet another aspect, the digital wealth management advisor's artificial intelligence program provides a suggested course of action based on the customer's financial question.

In another aspect, a digital wealth management system is provided. The digital wealth management system includes a digital wealth management advisor on a computer that is operatively connected to a network. The digital wealth management advisor has an information-gathering unit that receives a customer's proposed course of action in a financial transaction. The digital wealth management advisor further includes a financial-processing unit communicatively coupled to the information-gathering unit that retrieves the customer's financial data and processes the projected financial future of the customer if the customer proceeds with their proposed course of action in the financial transaction. The financial-processing unit is communicably coupled to an information-production unit that instructs a display device of the computer to display the projected financial future of the customer if the customer proceeds with their proposed course of action in the financial transaction.

In another aspect, the digital wealth management system's financial-processing unit provides a suggested course of action for proceeding in the financial transaction that is different than the customer's proposed course of action for proceeding in the financial transaction.

In still another aspect, the digital wealth management system's financial-processing unit pushes back if the customer intends to proceed with their proposed course of action in the financial transaction by suggesting a course of action for proceeding in the financial transaction that is different than that of the customer's proposed course of action for proceeding in the financial transaction.

Other aspects, objectives, and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 illustrates a Digital Wealth Management System according to one aspect of the present application;

FIG. 2 illustrates one embodiment of a computer of the Digital Wealth Management System of FIG. 1;

FIG. 3 illustrates another embodiment of a computer of the Digital Wealth Management System illustrated in FIG. 1;

FIG. 4 illustrates one example of the operation of the Digital Wealth Management System of FIG. 1; and

FIG. 5 illustrates another example of the operation of the Digital Wealth Management Advisor of FIG. 1.

While the invention will be described in connection with certain preferred embodiments, there is no intent to limit it to those embodiments. On the contrary, the intent is to cover all alternatives, modifications, and equivalents as included within the spirit and scope of the invention as defined by the appended claims.

The accompanying drawings incorporated in and forming a part of the specification illustrate several aspects of the present invention and, together with the description, serve to explain the principles of the invention. In the drawings:

### DETAILED DESCRIPTION OF THE INVENTION

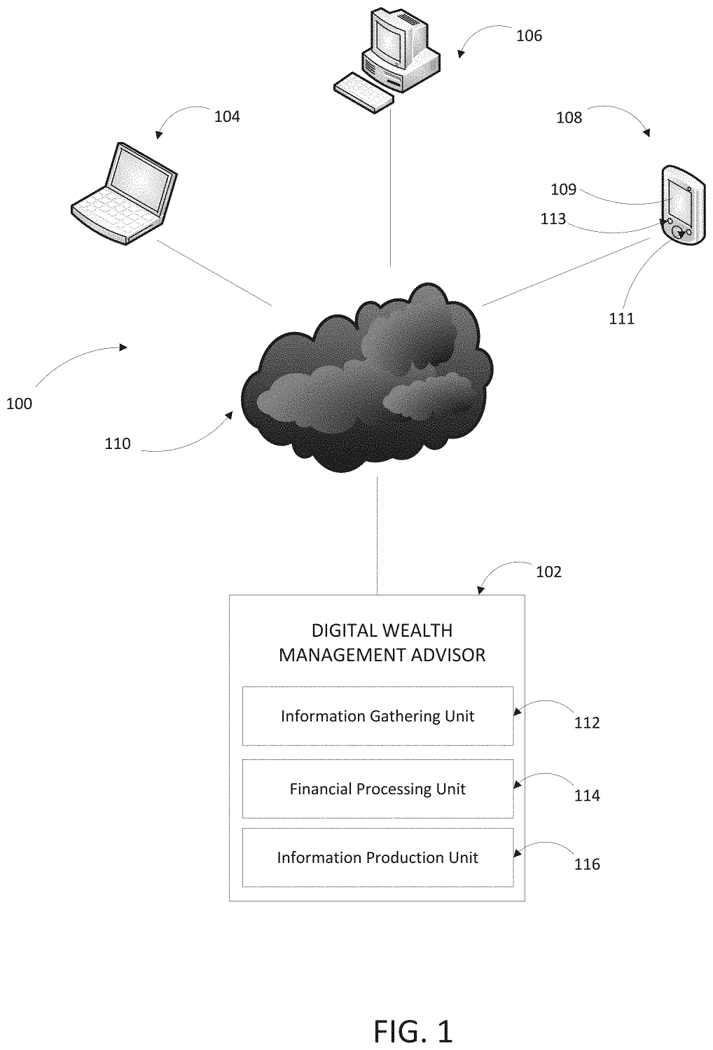

FIG. 1 depicts a block diagram of a Digital Wealth Management System (“DWMS”) 100 suitable for use with the methods and systems consistent with disclosure of the present application. As will be discussed herein, the DWMS 100 uses live financial data of a customer to provide a financial answer to any financial question posed by the customer, such as, but not limited to, questions regarding asset allocation, recommendations on the maximum dollar amount to contribute to retirement plans, the customer's discretionary income, the customer's after-tax income, the customer's retirement contributions, the customer's level of savings every year, the customer's lifetime planning beginning with the customer's first pay check, the customer's purchasing of their first home, the customer's savings related to their children's college education, any large purchases or expenses for the customer, such as, but not limited to, the cost of a wedding, the cost of buying long-term health care or self-insurance, and the amount the customer will need at retirement to sustain their lifestyle until at least age 94 or even older.

The DWMS 100 comprises a plurality of computers 102, 104, 106, and 108 connected via a network 110. The network 110 can be any type of network generally known in the art that allows communication between computers 102, 104, 106, and 108, such as, but not limited to a circuit-switched network or a packet-switched network. As will also be understood, the network 110 can include a multitude of interconnected networks, such as, but not limited to a local area network, a wide area network, such as, but not limited to, the Internet, a telephone network, such as, but not limited to telephone networks with dedicated communication links, a connection-less network, or a wireless network.

In one embodiment, the network 110 is the Internet and each of the computers 102, 104, 106, and 108 of the DWMS 100 is connected to the network 110 via any suitable communication link generally known in the art, such as, but not limited to, a dedicated communication line or a wireless communication link.

As illustrated, computer 108 includes a display 109, a microphone 111, and a speaker 113. The display 109 may be any type of display generally known in the art, such as, but not limited to a touch screen display. As will be understood, this allows a customer to enter information into the computer 108. As will also be understood, the computer 108 may also include a speech recognition program and/or voice recognition, such that a customer can communicate with the DWMS 100 using the microphone 111 and the DWMS 100 can communicate to the customer via the speaker 113.

Thus, according to one aspect of the present application, a DWMS 100 is provided in which the customer is able to communicate financial questions and receive financial advice from the DWMS 100 without the need to input financial information into the computer 108 and without the need to review the answer to the financial questions on the display 109 of the computer 108 because the financial information is entered into the DWMS 100 via the customer's voice using the microphone 111 and the financial question will be answered by the DWMS 100 using the speaker 113.

As will also be understood, computers 102, 104, and 106 may also include a microphone 111 and speaker 113, such that they can used by the customer in a similar manner to computer 108, as discussed above.

In FIG. 1, computer 102 serves as a Digital Wealth Management Advisor (“DWMA”) of the DWMS 100. As illustrated, the DWMA 102 includes an information-gathering unit 112, a financial processing unit 114, and an information production unit 116. As will be discussed in detail below, the information-gathering unit 112, the financial processing unit 114 and the information production unit 116 of the DWMA 102 work together to receive a financial question posed by a customer, determine a customer's current financial position, and, unlike the current web-based financial advisors, provide actual financial advice to the customer after taking into account the totality of the customer's financial timeline including the customer's financial history, the customer's current financial position, and the customer's projected financial needs.

As will be appreciated, other embodiments of the DWMS 100 can have any number or type of computers connected by any number or type of networks. In one embodiment, computer 102 may include the information-gathering unit 112 as well as one or more of the financial-processing units 114. However, the information-production unit 116 may also reside on a different computer than computer 102.

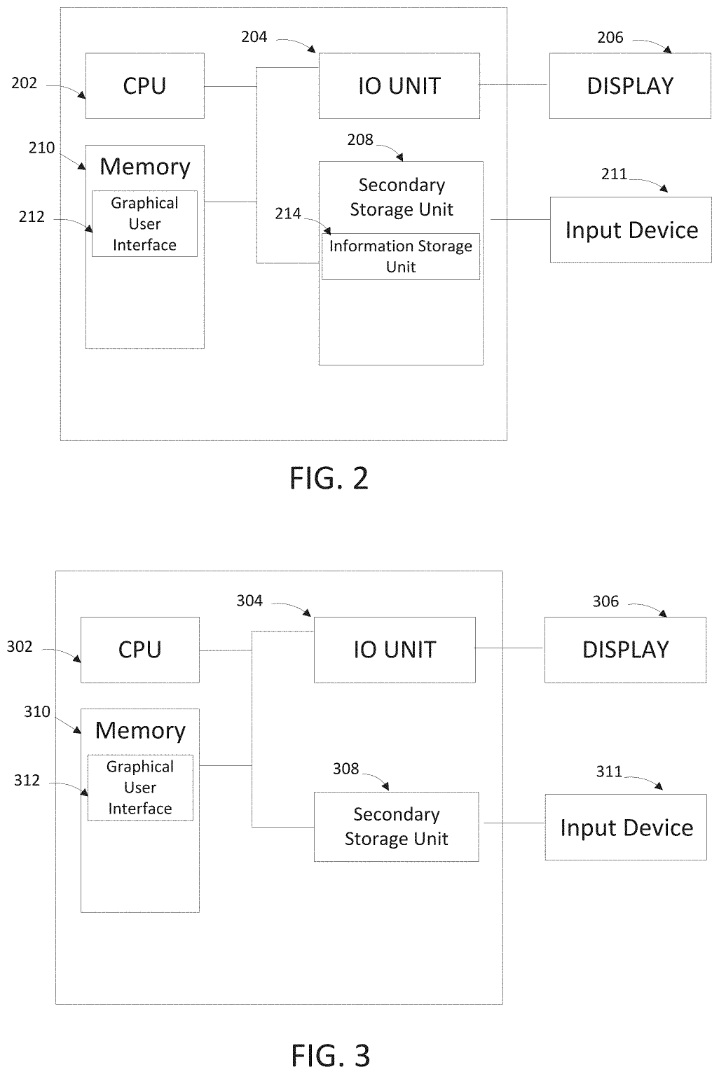

Turning to FIG. 2, further illustrating the computer 102 of the DWMS 100 of FIG. 1, the computer 102 includes a central processing unit (CPU) 202, an input/output (IO) unit 204, a display device 206 communicatively coupled to the IO Unit 204, a secondary storage device 208, and a memory 210. The computer 102 also includes an input device 211, which can be any input device generally known in the art, such as but not limited to, a keyboard, a mouse, a digitizer, or a speech processor. As will also be understood, the computer 102 may also include one or more input devices 211, such that the computer 102 can include a keyboard, a mouse, a digitizer, and a speech processor at the same time.

The memory 210 of the computer 102 includes a Graphical User Interface (“GUI”) 212 that can gather information from the customer that is entered into the computer 102 via the display device 206 and I/O unit 204 as described herein. The GUI 212 can be any interface generally known in that art that is capable of being displayed on the display device 206, such as, but not limited to, a web page, a display panel in an executable program, or any interface capable of being displayed on an electronic device. As will be understood, in other embodiments the GUI 212 could be stored at any other location within the computer 102 having storage capabilities, such as, but not limited to the secondary storage unit 208.

According to one aspect of the present application, the GUI 212 can be displayed using any commercially available hypertext generally known in the art, such as, but not limited to, hypertext markup language (“HTML”) viewing software or viewing software for any other markup language. In one embodiment, the HTML viewing software is Microsoft Internet Explorer. In another embodiment, the HTML viewing software is Google Chrome.

As also illustrated, the secondary storage unit 208 of the computer 102 may also include an information storage unit 214. The information storage unit 214 may be any type of database generally known in the art, such as but not limited to, a rational database. In one embodiment, the information storage unit includes a rational database, such as, but not limited to, Microsoft's SQL or Oracle.

Turning to FIG. 3, illustrating the computers 104, 106, and 108 of the Digital Wealth Management System 100 of FIG. 1, as illustrated, computers 104, 106, and 108 include a central processing unit (CPU) 302, an input output (IO) unit 304, a display device 306 communicatively coupled to the IO Unit 304, a secondary storage device 308, and a memory 310. The computers 104, 106, and 108 also include an input device 311. The input device 311 can be any type of input device generally known in the art, such as but not limited to, a keyboard, a mouse, a digitizer, or a speech processor. As will also be understood, the computers 104, 106, and 108 may also include one or more input devices 211, such that the computers 104, 106, and 108 can each include a keyboard, a mouse, a digitizer, and a speech processor at the same time.

The memory 310 of computers 104, 106, and 108 include a GUI 312, which is used to gather information from a customer via the display device 306 and IO unit 304 as described herein. The GUI 312 can be any interface generally known in the art, that is capable of being displayed on the display device 306, such as, but not limited to, a web page, a display panel in an executable program, or any interface capable of being displayed on an electronic device. As will be understood, in other embodiments the GUI 312 could be stored at any other location within computers 104, 106, and 108 that have storage capabilities, such as, but not limited to the secondary storage unit 308.

According to one aspect of the present application, the GUI 312 can be displayed using any commercially available markup language generally known in the art, such as, but not limited to, HTML viewing software. In one embodiment, the HTML viewing software is Microsoft Internet Explorer. In another embodiment, the HTML viewing software is Google Chrome.

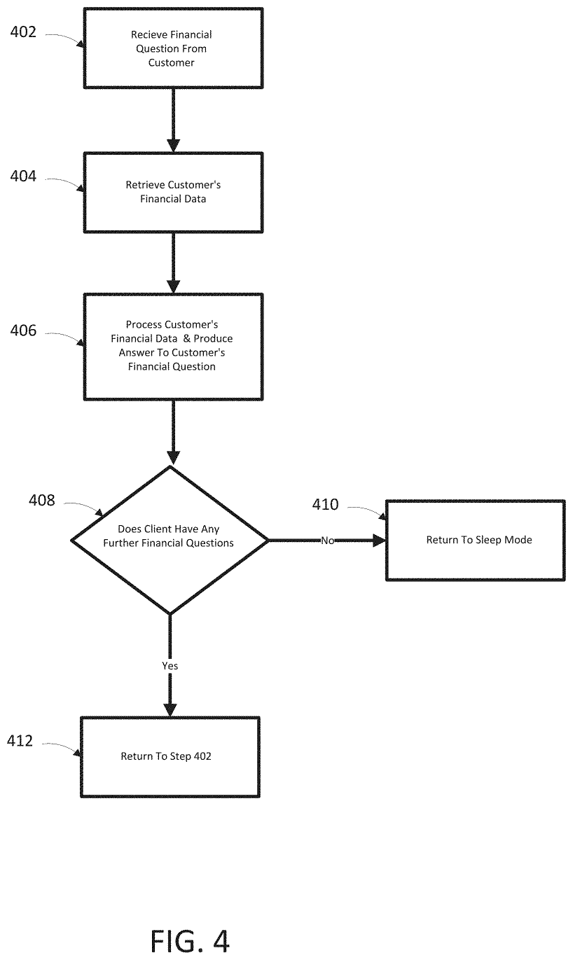

Turning to FIG. 4, which illustrates one example of the operation of the DWMS 100. In step 402, the DWMA 102 receives a financial question input by a customer using a computer, such as, but not limited to, computers 102, 104, 106, and 108. In step 404, the information-gathering unit 112 communicates with the information-storage unit 214 to gather the customer's current financial data indexed within a database of the information storage unit 214. The information gathered from the information-storage unit 214, may include, but is not limited to, the net worth of the customer, the total cash on hand that is available to the customer, or the investment assets of the customer. As will be understood, the information storage unit 214 of the DWMS 100 can be customized to store or index any type of financial data relevant to that individual customer, such that the DWMS 100 can provide specific and tailored answers to a customer's financial questions based on the totality of the customer's specific financial situation.

In step 406, the financial-processing unit 114 receives the financial question posed by the customer from the information-gathering unit 112 and the customer-specific financials retrieved from the information-storage unit 214. The financial-processing unit 114 will then calculate an answer to the financial question posed by the customer based on the customer's specific financial data. The financial-processing unit 114 is equipped with artificial intelligence that can project a future financial position of the customer based on the customer's previous financial history along with their present financial position. The artificial intelligence used by the financial-processing unit 114 can then provide the customer with an answer to the financial question they posed in step 402.

As will be understood, the DWMA 102 builds histories on each customer to learn their tendencies, which better enables the DWMA 102 to provide sound financial advice to the customer so that they may make a sound financial decision. Further, unlike human wealth advisors who only episodically meet with their customers, the DWMA 102 is always available to address a customer's question.

In step 408, the DWMA 102 displays a prompt to the customer asking if they have any further financial questions that need to be processed by the DWMA 102. If the customer responds to the prompt with a “No,” or if an allotted amount of time elapses, the DWMA 102 enters a sleep mode, as indicated in step 410, in order to conserve energy until the customer activates the DWMA at a later time.

If the customer responds to the prompt with a “Yes,” the DWMA 102 returns to step 402 and the information-gathering unit 112 stands at the ready to receive the second financial question from the customer. As will be understood, the second financial question asked by the customer may or may not be related to the first financial question asked by the customer. However, as will be understood, the artificial intelligence implemented into the DWMA 102 gathers and stores the data from each interaction with the customer, such that if the second financial question posed by the customer is related to the first financial question, then the DWMA 102 is capable of taking into account the information and providing an answer to the second question that takes into account the first question asked by the customer.

As an example, if the first question posed to the DWMA 102 by the customer was “If I take $50,000 out of my 401(k) to use as a down payment on my first house how will this affect my projected assets at retirement?” and the second financial question posed to the DWMA 102 is “If I take $50,000 out of my stock portfolio to use as a down payment on my first house how will this affect my projected assets at retirement?” the DWMA 102 will understand that the customer would like to withdraw $50,000 of assets for use as a down payment on a house. Thus, unlike other web-based financial advisors, the DWMA 102 is capable of taking into account the totality of the customer's financial position, along with projecting the customer's current and future financial needs.

As such, unlike other web- or software-based financial advisors, the DWMA 102 may suggest first using the customer's discretionary cash on hand assets for the down payment, then, if needed, withdrawing $10,000 from the customer's 401(k) as it would not be penalized because the DWMA 102 would know that the customer was a first-time home buyer and that he had the money in the 401(k) for the required amount of time to withdraw it without a penalty, and, if yet still more money was needed for the down payment, withdrawing the remaining amount from the customer's stock portfolio.

Therefor, unlike other web-based financial advisors, which would have simply performed a calculation and returned an answer to the customer based solely on the calculation and clearly does not take into account the totality of the customer's financial position, the artificial intelligence program incorporated into the DWMA 102 is providing the customer with actual financial advice based on the customer's specific financial history, current financial position, and projected financial need. Thus, the DWMS 100 including the DWMA 102 disclosed herein provides the customer with actual financial advice unlike other web-based financial advisors, such that the DWMS 100 disclosed herein is capable of guiding a customer's finances from the cradle to the grave.

As will be understood, the customer can repeatedly ask the DWMA 102 any number of financial questions, which the DWMA 102 will compute and provide an answer to as indicated in FIG. 4. As will also be appreciated, unlike with human wealth advisors, the DWMA 102 will be available to answer any of the customer's questions at any time of day or night and without the additional costs associated with having to contact a human wealth advisor.

Further, the DWMA 102 will also be able to answer simpler financial questions that a customer may not feel comfortable about or that it may not be fiscally responsible for the customer to contact a human wealth advisor about, such as the impact a down payment for a car may have on a customer's financial future, or if the cost of a projected vacation may have a significantly negative impact on the customer's financial future. As such, the DWMA 102 provides a means for a customer to gain an acute financial insight into even the smaller financial decisions made by the customer, which, over time, can create a large impact on a customer's projected financial position.

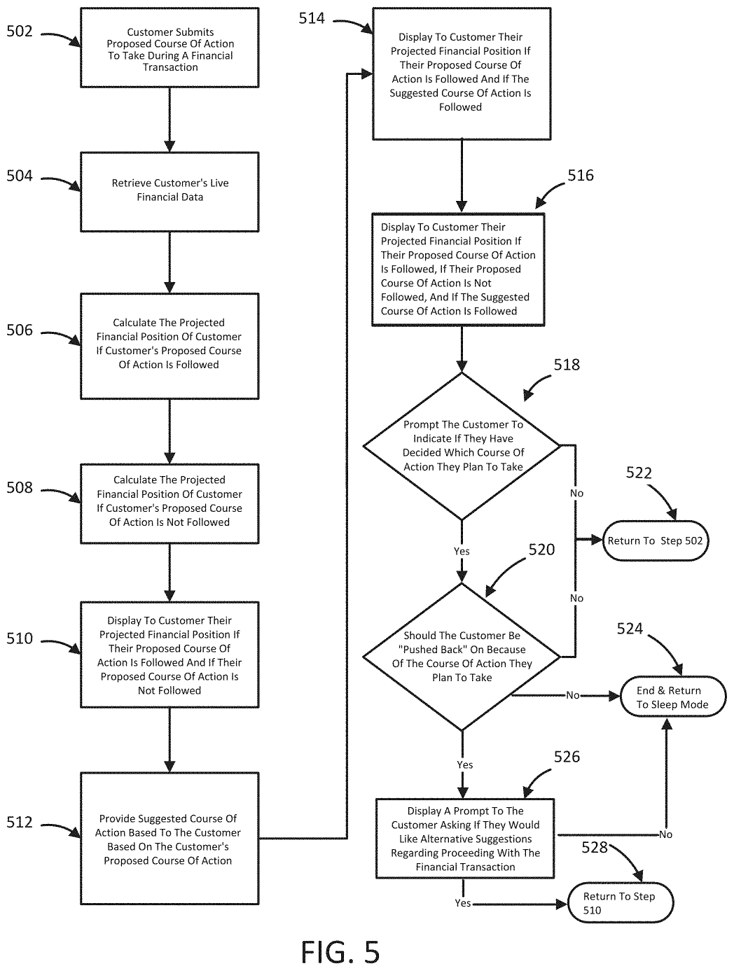

Turning to FIG. 5, illustrating one example of a decision tree that can be processed by the DWMA 102 of the present application. In this embodiment, a customer will propose to the DWMA 102 a financial course of action that the customer is considering. In response, the information gathering unit 112 will retrieve the customer's live financial data, as indicated by step 504. The DWMA 102 can then respond by evaluating the customer's proposed course of action based on the customer's live financial data.

As will be understood, according to one aspect of the present application, a customer can communicably couple their DWMS 100 to any financial institution, such as, but not limited to a bank account, a credit card account, a mortgage account, an investment account, or a retirement account. Further, once the customer has communicably coupled their DWMS 100 to a financial institution, the DWMS 100 will automatically connect to the financial institution and retrieve the customer's live financial data when the customer prompts the DWMS 100 with a financial question, thereby, allowing the DWMS 100 to access the live financial data of a customer and provide live financial advice based on the customer's actual and current financial position.

Turning to step 506, the financial-processing unit 114 processes the customer's current financial position and determines the future financial position of the customer if their proposed course of action is taken. In step 508, the financial-processing unit 114 determines the customer's projected financial position if the customer's proposed course of action is not followed. Next, the DWMA 102 determines the difference between the customer's projected financial future if the customer's proposed course of action is followed and if the customer's proposed course of action is not followed as indicated by step 510.

Next, the DWMA 102 provides suggestions to the customer based on the customer's proposed course of action, as indicated at step 512. Then the DWMA 102, calculates a difference between the DWMA's 102 suggested course of action as determined in step 512 and the customer's proposed course of action, as provided by the customer at step 502. The DWMA 102 then provides to the customer the customer's projected financial future if the customer proceeds with their proposed course of action and if the customer proceeds with the DWMA's suggested course of action, as indicated at step 514.

The DWMA 102 can also display to the customer all the options they currently have on the table including if the customer proceeds with their proposed course of action, if the customer proceeds without proceeding their proposed course of action, and if the customer proceeds with the DWMA's suggested course of action, as indicated at step 516.

Next, the customer is asked if they would like to proceed with their proposed course of action, proceed without taking the customer's proposed course of action, or proceed with the DWMA's suggested course of action, as indicated by step 516. If the customer indicates that they have not decided how they would like to proceed at step 518, the DWMA then returns the customer to step 502, as indicated by step 522.

If the customer indicates at step 518 that they have decided how they would like to proceed with the financial transaction, then the DWMA 102 determines if it should “push back” on the customer's financial decision as indicated at step 520. If the DWMA 102 determines that the decision made by the customer is financially sound, or, at the very least, not going to significantly negatively impact the customer's financial future, then the DWMA 102 will determine that no “push back” is needed at step 520 and will allow the customer to proceed with the financial transaction. The DWMA 102 will then end the process and return to sleep mode as indicated by step 524.

If the DWMA 102 determines that the decision made by the customer is not financially sound or that it is going to significantly negatively impact the customer's financial future, the DWMA 102 will determine that it should “push back” on the customer's financial decision at step 520. The DWMA 102 will “push back” on the customer's financial decision at 520 by asking the customer at step 526 if they would like to consider alternative suggestions to their proposed financial decision. If the customer answers “No,” then the DWMA 102 ends the financial decision process and enters a sleep mode at step 524. If the customer answers “Yes,” then the DWMA 102 returns the customer to step 510 as indicated at step 528, where the customer can continue using the DWMA 102 indefinitely until they feel comfortable with the impact their decision will have on their financial future.

As discussed above, one of the many benefits of the DWMS 100 disclosed herein is that it can be tailored to each individual customer. One of the reasons that the DWMS 100 can be tailored to each customer is that each customer can have a DWMS 100 that is modeled after their individual needs.

An additional benefit of the DWMS 100 disclosed herein is that it is also easily adaptable to financial changes that may impact individual customers. For example, once a new tax law has been passed, the DWMS 100 can be modeled to reflect those changes in the tax law within several days for the entire customer base. Still further, once tax reform has passed, the specific changes in the tax law that reflect each individual customer can be reflected by the remodeling of the DWMS 100, such that each customer's specifically tailored DWMS 100 will immediately begin taking into account the changes in the tax law and begin working toward customizing a financial plan that will maximize the financial growth of the assets for each customer based on the changes to the tax law.

Another benefit of the DWMS 100 disclosed in the present application is that it can run financial analysis of and provide tailored financial advice on a wide range of asset classes, such as, but not limited to, life insurance options, annuities, large-cap U.S. value, growth, small-cap value, emerging growth, annuities, tax exempt bonds, treasury bonds, corporate bonds, and real estate. In addition, the DWMS 100 can provide custom analysis for each asset class that is customized to each customer including, but not limited to, providing expected returns for each asset class as well as probability analysis for each asset class.

All references, including publications, patent applications, and patents cited herein are hereby incorporated by reference to the same extent as if each reference were individually and specifically indicated to be incorporated by reference and were set forth in its entirety herein.

The use of the terms “a,” “an,” “the,” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein is merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A digital wealth management system comprising:
a digital wealth management advisor comprising an information-gathering unit, a financial-processing unit, and an information-production unit; and
a customer-accessible computer;
wherein the digital wealth management advisor and the customer-accessible computer are connected to a network, such that the customer-accessible computer and the digital wealth management advisor are communicable over the network; and
wherein the information-gathering unit receives a question input by a customer on the customer-accessible computer, the financial-processing unit determines an answer to the question, and the information-production unit sends the answer to the customer-accessible computer.

2. The digital wealth management system of claim 1, wherein the customer-accessible computer is a cellular device having a microphone and a speaker.

3. The digital wealth management system of claim 2, wherein the cellular device is configured to record one or more words using the microphone and interpret the recorded one or more words using voice-recognition technology to generate the question, such that a user can ask the question using the microphone.

4. The digital wealth management system of claim 2, wherein the cellular device is configured to generate audio using the speaker based on the answer using speech-generation technology, such that the customer receives the answer via the speaker.

5. The digital wealth management system of claim 1, wherein the financial-processing unit is programmed with artificial intelligence configured to obtain live financial data relating to the customer and obtain historical financial data relating to the customer and wherein the financial processing unit produces the answer based at least in part on the live financial data relating to the customer and the historical financial data relating to the customer

6. The digital wealth management system of claim 2, wherein the cellular device contains a processor communicatively coupled to a local memory containing instructions that, when executed by the processor, implement the digital wealth management advisor.

7. A digital wealth management advisor comprising an information-gathering unit configured to receive a financial question input on a computer by a customer;
wherein the information-gathering unit is communicably coupled to a financial processing unit over a network, such that the information-gathering unit submits the financial question received by the information-gathering unit to the financial-processing unit;
wherein the financial-processing unit retrieves financial data relating to the customer and processes the financial question in view of the retrieved financial data to generate an answer to the financial question;
wherein the financial-processing unit is communicably coupled to an information production unit;
wherein the information-production unit is communicably coupled to a display device of the computer; and
wherein the information-production unit instructs the display device on the computer to display the answer to the financial question for review by the customer.

8. The digital wealth management advisor of claim 7, wherein the computer is an electronic device.

9. The digital wealth management advisor of claim 7, wherein the digital wealth management advisor is an application downloaded to a local memory on the electronic device and implemented by a processor on the electronic device that is communicably coupled to the local memory.

10. The digital wealth management advisor of claim 7, wherein the retrieved financial data comprises the historical financial data relating to the customer and current financial data related to the customer.

11. The digital wealth management advisor of claim 7, wherein the computer includes a speech-recognition program configured to translate recorded audio into machine-readable instructions and wherein the customer audibly submits the financial question to the information-gathering unit.

12. The digital wealth management advisor of claim 11, wherein the computer includes a speaker and a speech-generation program, such that the information-production unit audibly provides the customer with the answer to the financial question.

13. The digital wealth management advisor of claim 10, wherein the financial-processing unit is communicatively coupled to an artificial intelligence program; and
wherein the artificial intelligence program provides the answer to the financial question.

14. The digital wealth management advisor of claim 13, wherein the artificial intelligence program determines the answer to the financial question based at least in part on the historical financial data.

15. The digital wealth management advisor of claim 14, wherein the artificial intelligence program determines the answer to the customer's question based on the customer's current financial position.

16. The digital wealth management advisor of claim 15, wherein the artificial intelligence program determines projected financial data for the customer based on the historical financial data and the current financial data.

17. The digital wealth management advisor of claim 14, wherein the answer determined by the artificial intelligence program comprises a suggested course of action based on the financial question.

18. A digital wealth management system comprising:
a computer comprising a display device and a processor communicatively coupled to a memory containing one or more instructions that, when executed by the processor, implement a digital wealth management advisor, wherein the computer is operatively connected to a network, the digital wealth management advisor comprising an information-gathering unit that receives a proposed course of action for the customer in a financial transaction; and
a financial-processing unit communicatively coupled to the information-gathering unit configured to retrieve financial data relating to the customer and determine a projected financial future for the customer based at least in part on the retrieved financial data and the proposed course of action for the customer in the financial transaction, the financial-processing unit communicably coupled to an information production unit that causes the display device to display the projected financial future for the customer.

19. The digital wealth management system of claim 18, wherein the financial-processing unit provides a suggested course of action for proceeding in the financial transaction that is different than the proposed course of action for the customer in the financial transaction.

20. The digital wealth management system of claim 19, wherein the financial-processing unit generates an alert for the customer if the proposed course of action in the financial transaction will produce an outcome that differs from the suggested course of action for proceeding in the financial transaction.
